(19) United States
(12) Patent Application Publication
(10) Pub. No.: US 2025/0287240 A1
(43) Pub. Date: Sep. 11, 2025

(54) SYSTEMS AND METHODS FOR PRECISION LOCALIZATION OF SHORT-RANGE WIRELESS BEACONS

(71) Applicant: Verizon Patent and Licensing Inc., Basking Ridge, NJ (US)

(72) Inventors: Clas Veibäck, Söderköping (SE); Per Skoglar, Linköping (SE); Rickard Karlsson, Linkoping (SE); Carl Martin Estgren, Linkoping (SE); David Törnqvist, Linghem (SE)

(73) Assignee: Verizon Patent and Licensing Inc., Basking Ridge, NJ (US)

(21) Appl. No.: 18/598,390

(22) Filed: Mar. 7, 2024

(51) Int. Cl. H04W 24/10; H04W 4/029

(52) U.S. Cl. CPC H04W 24/10; H04W 4/029

(57) ABSTRACT

A system described herein may receive wireless metrics and location information associated with a set of first devices over a particular time window. The system may receive a set of wireless metrics associated with a second device over the particular time window. The system may determine measures of similarity between the set of wireless metrics associated with the second device, and the sets of wireless metrics associated with the set of first devices. The system may determine a plurality of weights based on the determined measures of similarity, where each weight is associated with the second device and a respective first device of the set of first devices. The system may apply the weights to locations of corresponding first devices, and determine a location of the second device, relative to one or more of the first devices, based on applying the weights.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. UEs may be used for location-based services, such as receiving, determining, reporting, etc. their own respective location information or location information of other devices, objects, etc. For example, a particular UE may utilize Global Positioning System (“GPS”)-based techniques to determine its own geographical location, a wireless network may use triangulation techniques to determine the geographical location of the UE, etc.

### BRIEF DESCRIPTION OF THE DRAWINGS

FIG. 1 illustrates an example overview of one or more embodiments described herein;

FIG. 2 illustrates an example process for localizing mobile beacons within a particular space using weighted wireless metrics, in accordance with some embodiments;

FIG. 3 illustrates an example of a set of wireless metrics measured or reported by a particular device over a particular time period, in accordance with some embodiments;

FIG. 4 illustrates an example of multiple sets of wireless metrics measured or reported by a set of devices over a particular time period, in accordance with some embodiments;

FIGS. 5 and 6 illustrate example sets of weights reflecting similarity scores between wireless metrics associated with respective mobile beacons and respective reference beacons, in accordance with some embodiments;

FIGS. 7, 8A, and 8B illustrate examples of localizing a set of mobile beacons within a given space based on locations of a set of reference beacons within the given space and weights associated with respective mobile beacons and the set of reference beacons, in accordance with some embodiments;

FIG. 9 illustrates an example environment in which one or more embodiments, described herein, may be implemented; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein may provide the precise localization of beacon devices (e.g., wireless signal-emitting devices), leveraging the wireless capabilities of one or more network-enabled tracker devices (e.g., devices with wireless connectivity, such as UEs) to facilitate the precise localization of relatively many such beacon devices with the assistance of relatively few network devices. As such, the beacon devices may be able to have relatively basic wireless functionality or hardware (e.g., a transmitter with the ability to transmit wireless signals, without a receiver that has the ability to receive wireless signals), but may still be able to be localized with the precision of network devices (e.g., devices that include wireless transmitters and receivers and are able to send and receive wireless signals). In this sense, fewer devices with wireless connectivity and access to a wireless network may be used when determining the precise locations of numerous wireless beacon devices. Further, in accordance with some embodiments, the locations of the mobile beacons may be determined without requiring knowledge of the locations of the tracker devices, thus eliminating the need for tracker devices to integrate location determination hardware and/or to implement location determination techniques, such as Global Positioning System (“GPS”)-based techniques, an indoor positioning system, or the like.

Further, in accordance with some embodiments, the precise locations of such beacon devices may be able to be determined within a given space or geographical region (e.g., a floor of an office building, a sports venue, a warehouse floor, etc.). Such embodiments may be beneficial in scenarios where wireless network coverage (e.g., signal strength or quality of radio signals to or from a base station of a wireless network) is lacking, such as inside buildings, in remote geographical areas, etc. Additionally, in accordance with some embodiments, the precise locations of beacon devices may be able to be performed in three dimensions. Such embodiments may provide enhanced localization as compared to two-dimensional location determination techniques (e.g., the latitude and longitude coordinates of a given device).

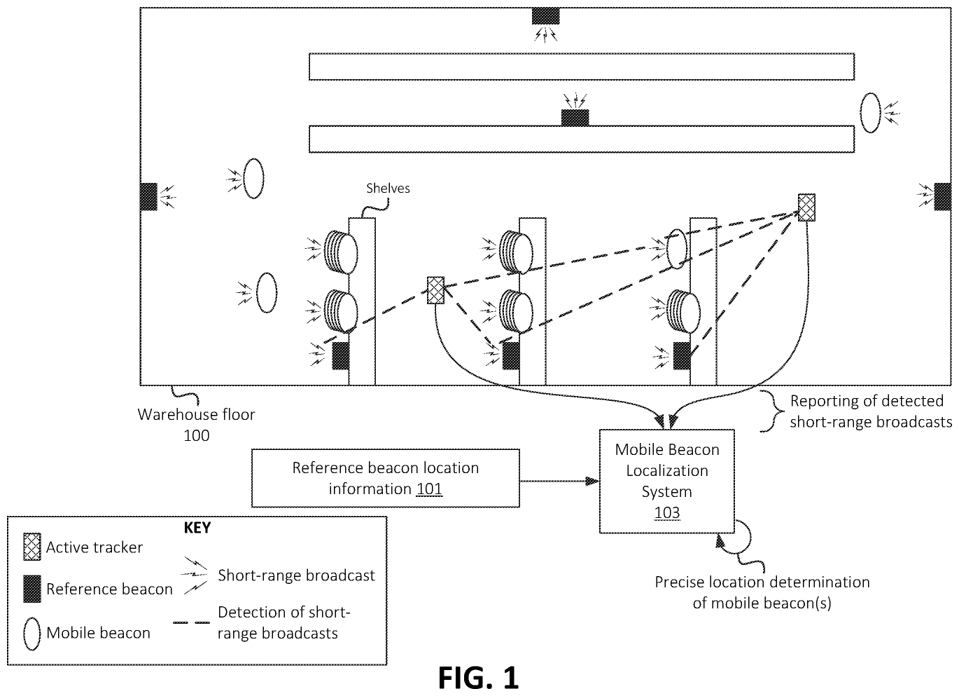

FIG. 1 illustrates an example overview of some embodiments. In this example, warehouse floor 100 is shown as an example space in which reference beacons, mobile beacons, and active trackers may be located. Other physical features may be present on warehouse floor as well, such as walls, shelves, doorways, corridors, etc. Such physical features may potentially interfere with or otherwise alter the transmission or reception of wireless signals of devices that are present on warehouse floor 100.

As referred to herein, “reference beacons” and “mobile beacons” may be capable of short-range communications such as Bluetooth®, Near Field Communication (“NFC”), or other short-range wireless communications (e.g., communications in which radios, antennas, transceivers, etc. that are physically proximate to each other may wirelessly communicate). In some scenarios, some or all of the reference beacons and/or mobile beacons may only be capable of transmitting (e.g., broadcasting) wireless signals, but may not be capable of receiving wireless signals. For example, one or more reference beacons and/or mobile beacons may include wireless transmitters, but may not include wireless receivers. As another example, reference beacons and/or mobile beacons may include wireless receivers and transmitters, but may not be configured or able to use such receivers (e.g., may be configured to power off the receivers during certain times of the day as a power saving measure). In any event, embodiments described herein may determine the precise locations of the mobile beacons, without requiring that the mobile beacons or the reference beacons receive any wireless signals from any source.

Reference beacons may be attached, affixed, etc. within a given space, such as on walls, floors, ceilings, shelves, etc. of warehouse floor 100. In some embodiments, one or more reference beacons may be permanently attached or affixed within the given space, such as the respective locations of such reference beacons may be static. In some embodiments, one or more reference beacons may be mobile within the given space, but the respective locations of such reference beacons may be known or able to be determined in some way. Thus, while some examples below refer to reference beacons as being “fixed” or stationary, concepts described below with respect to reference beacons may also apply to beacons or other suitable devices that are not stationary, but for which their respective locations are able to be monitored, determined, etc. in some suitable manner.

Mobile beacons may be placed on, placed in, affixed to, integrated in, etc. objects such as pallets, boxes, vehicles (e.g., automated guided vehicles (“AGVs”)), robots, IoT devices, or the like. In general, mobile beacons may be used to monitor, track, etc. the location of such objects (e.g., within a particular space that includes reference beacons that are associated with known locations and/or locations that are otherwise able to be determined). As discussed above, mobile beacons may have relatively simple circuitry and/or logic, such as a wireless transmitter (e.g., that outputs wireless signals, such as wireless broadcasts that include a respective identifier of the mobile beacons).

In some embodiments, as discussed below, reference beacons may also be placed on, placed in, affixed to, etc. movable objects such as boxes, AGVs, etc. In such embodiments, the locations of such reference beacons may be able to be determined using any suitable localization technique, including localization techniques not explicitly discussed herein. That is, the locations of the reference beacons may be provided or made available as a factor based on which the locations of mobile beacons may be determined, in accordance with embodiments described herein. Such situations may occur, for example, when reference beacons and mobile beacons implement different techniques or have different capabilities, when reference beacons and mobile beacons are managed or provided by different entities (e.g., different organizations, different providers, etc.), etc. In this sense, the capability to determine or monitor the location of the reference beacons (e.g., whether the reference beacons are stationary or mobile) may be further leveraged to determine or monitor the location of mobile beacons, which may not be able to be localized in the same manner as the reference beacons. For example, embodiments described herein provide for the determination of the location of mobile beacons relative to the locations of reference beacons (e.g., devices for which the location is known, predetermined, or is otherwise able to be determined).

Active trackers may, in accordance with some embodiments, have the capability to receive, detect, etc. wireless signals. For example, active trackers may have wireless receivers, radios, antennas, etc. that are capable of receiving wireless signals, such as wireless broadcasts from reference beacons and mobile beacons. Active trackers may include, may be implemented by, may implement, and/or may be communicatively coupled to one or more UEs that have wireless network connectivity (e.g., connectivity to Internet Protocol (“IP”) networks such as the Internet, to one or more wireless networks such as a Long-Term Evolution (“LTE”) network or a Fifth Generation (“5G”) network, etc.).

Active trackers may use such network connectivity to communicate with Mobile Beacon Localization System (“MBLS”) 103, with each other, and/or with one or more other devices or systems. In some embodiments, MBLS 103 may be a network-accessible resource, such as an application server that is accessible via the Internet or some other network. In some embodiments, MBLS 103 may be implemented by an edge computing device of a wireless network, such as a Multi-Access/Mobile Edge Computing (“MEC”) device. In some embodiments, one or more of the operations described herein with respect to MBLS 103 may be performed by one or more active trackers or other suitable devices.

Active trackers may each detect, receive, etc. short-range wireless signals (e.g., broadcasts) from one or more reference beacons and/or mobile beacons on warehouse floor 100. Active trackers may identify the source of respective wireless signals (e.g., particular reference beacons and/or mobile beacons), such as based on identifiers (e.g., hardware identifiers, MAC addresses, etc.) included in the wireless signals. The active trackers may communicate with MBLS 103 to report detected short-range broadcasts as output by reference beacons and mobile beacons. In accordance with some embodiments, and as described in more detail below, MBLS 103 may utilize reference beacon location information 101 in conjunction with the information reported by one or more of the active trackers to determine the precise location (e.g., in two or three dimensions) of one or more of the mobile beacons on warehouse floor 100. For example, as discussed below, MBLS 103 may identify weights that reflect similarities between wireless signals emitted from one or more mobile beacons and wireless signals emitted from one or more reference beacons, and may apply the weights to the locations of the reference beacons in order to localize respective mobile beacons within warehouse floor 100. As discussed above, reference beacon location information 101 may indicate static or stationary locations of one or more reference beacons, and/or may be updated (e.g., in real time or near-real time) to include dynamic location information of one or more reference beacons. As discussed above, such scenarios may occur when reference beacons are affixed to or integrated in mobile objects such as AGVs, pallets, or the like, and where the locations of such reference beacons are able to be determined or monitored using any suitable technique.

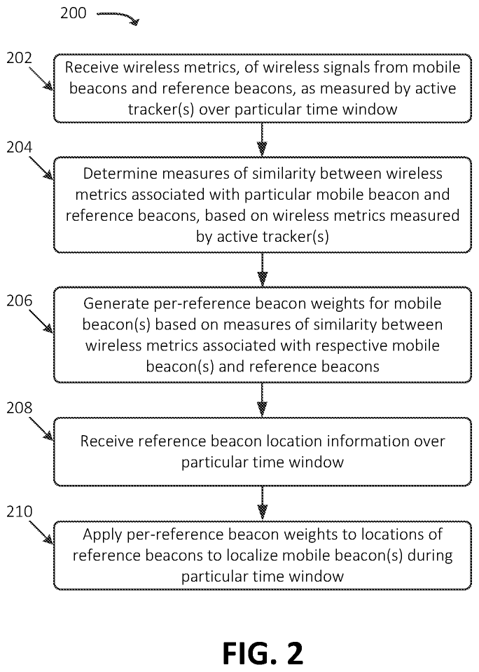

FIG. 2 illustrates an example process 200 for localizing one or more mobile beacons within a particular space using weighted wireless metrics, in accordance with some embodiments. In some embodiments, some or all of process 200 may be performed by MBLS 103.

As shown, process 200 may include receiving (at 202) wireless metrics, associated with wireless signals from one or more mobile beacons and one or more reference beacons, as measured by one or more active trackers. The received wireless metrics may be associated with a particular time period, time window, duration of time, etc. For example, the received wireless metrics may have been measured, reported, etc. by the active tracker over one second, five seconds, one minute, one hour, or some other suitable duration of time. In the examples discussed below, the wireless metrics are referred to as “signal strength” for the sake of example. In practice, similar concepts may apply for other wireless metrics such as Signal-to-Interference-and-Noise-Ratio (“SINR”), Received Signal Strength Indicator (“RSSI”), Reference Signal Received Power (“RSRP”), Reference Signal Received Quality (“RSRQ”), Channel Quality Indicator (“CQI”), Channel Impulse Response (“CIR”), and/or other metrics that indicate signal strength, signal quality, interference, etc.

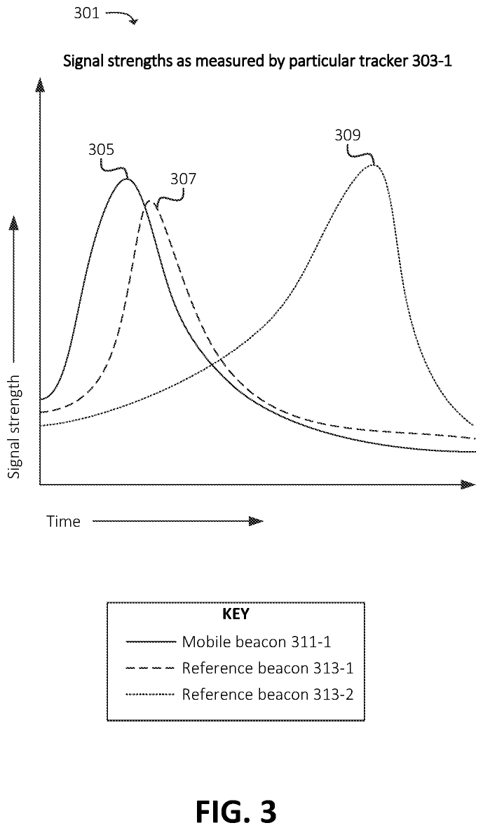

FIG. 3 illustrates graph 301, which represents an example set of signal strengths or other wireless metrics, as measured or reported by a particular active tracker 303 over a given time window. As shown, curves 305, 307, and 309 are plotted on graph 301. Curve 305 may be associated with mobile beacon 311. Specifically, for example, curve 305 may represent wireless metrics, as measured or reported by active tracker 303, and as output by a particular mobile beacon 311. Similarly, curve 307 may be associated with a first reference beacon 313-1, and curve 309 may be associated with a second reference beacon 313-2.

The Y-axis of graph 301 represents signal strength or other suitable wireless metrics. In some embodiments, the Y-axis of graph 301 and/or subsequent graphs may be pre-processed, normalized, etc. such that different ranges or types of values may be more readily represented by such graphs. On the other hand, in some embodiments, the Y-axis of graph 301 and/or subsequent graphs may be provided in terms of absolute or actual values (e.g., actual signal strength measurement values).

For the sake of explanation, curves 305-309 (and other curves discussed below) are referred to as “curves” that represent respective signal strength measurements over time. In practice, other types of functions, shapes, lines, plots, etc. (e.g., which may be multi-dimensional) may represent signal strengths as measured by one or more active trackers 303. Further, while smooth curves are provided in the illustrated examples, similar concepts may apply to scatter plots, line graphs, or other types of representations of signal strength measurements or other wireless metrics received over time.

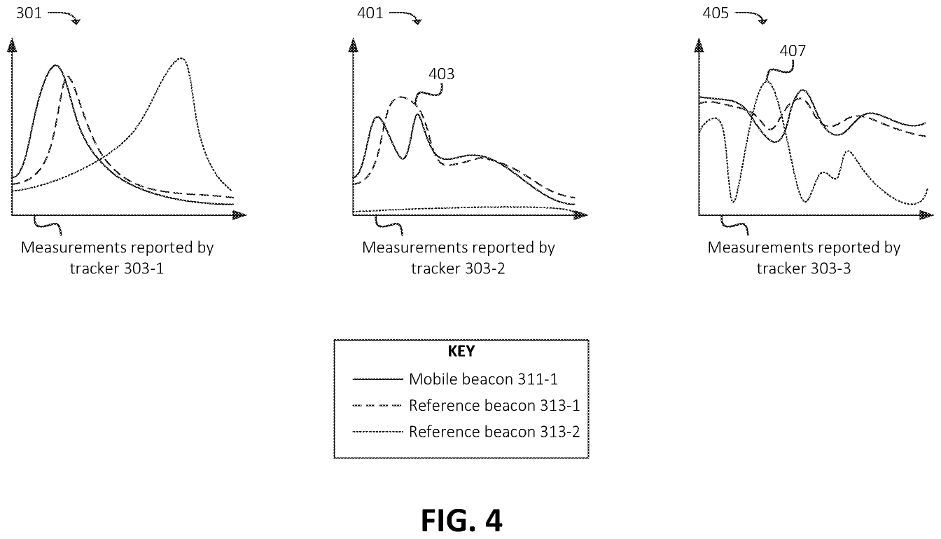

Some or all of the operations of process 200 may be performed with respect to multiple active trackers 303. For example, FIG. 4 illustrates an example of multiple sets of signal strength measurements, measured or reported by different active trackers 303 (i.e., active trackers 303-1, 303-2, and 303-3), over a particular time window. In addition to graph 301, graph 401 may represent signal strength measurements measured or reported by active tracker 303-2 (e.g., signal strengths of wireless signals transmitted by mobile beacon 311-1 and reference beacons 313-1 and 313-2). As one example, curve 403 of graph 401 may represent signal strength of wireless signals transmitted (e.g., broadcasted) by reference beacon 313-1, and as measured or reported by active tracker 303-2. Graph 405 may represent signal strength measurements measured or reported by active tracker 303-3. Example curve 407 of graph 405 may represent signal strength of wireless signals transmitted (e.g., broadcasted) by reference beacon 313-2, and as measured or reported by active tracker 303-3. Assume, for the examples discussed herein, that graphs 301, 401, and 405 correspond to the same particular time window.

Returning to FIG. 2, process 200 may further include determining (at 204) measures of similarity between wireless metrics associated with a particular mobile beacon 311 and wireless metrics associated with one or more reference beacons 313. For example, MBLS 103 may utilize pattern matching techniques, image recognition techniques, artificial intelligence/machine learning (“AI/ML”) techniques, statistical analysis techniques, or other suitable techniques to determine such measure of similarity. Referring to example graph 301 shown in FIGS. 3 and 4, MBLS 103 may determine a first measure of similarity between curves 305 and 307, and a second measure of similarity between curve 305 and 309. The first measure of similarity may represent how similar the wireless metrics, as measured by active tracker 303-1, of wireless signals transmitted by mobile beacon 311 are to wireless metrics, as measured by active tracker 303-1, of wireless signals transmitted by reference beacon 313-1. The second measure of similarity may represent how similar the wireless metrics, as measured by active tracker 303-1, of wireless signals transmitted by mobile beacon 311 are to wireless metrics, as measured by active tracker 303-1, of wireless signals transmitted by reference beacon 313-2.

Generally, a higher measure of similarity between wireless signals associated with mobile beacon 311 to wireless signals associated with a given reference beacon 313 (e.g., as measured by a particular active tracker 303 at a given time) may indicate that mobile beacon 311 is relatively close to such reference beacon 313 at the given time. On the other hand, a lower measure of similarity between wireless signals associated with mobile beacon 311 to wireless signals associated with a given reference beacon 313 (e.g., as measured by a particular active tracker 303 at a given time) may indicate that mobile beacon 311 is relatively farther from such reference beacon 313 at the given time.

For example, as a given active tracker 303 moves around within a given space, factors such as distance, environmental factors, etc. may cause wireless signals received by active tracker 303 to exhibit higher or lower signal strengths (or other metrics). If those factors impact mobile beacon 311 and a given reference beacon 313 in a similar manner, this may indicate that mobile beacon 311 and such reference beacon 313 are located relatively close to each other.

As noted above, such factors may come into play when mobile beacon 311 and a given reference beacon 313 are both mobile but move together (e.g., are affixed to or are otherwise located on the same moving object). For example, if mobile beacon 311 and a given reference beacon 313 are on a moving object (even if active tracker 303 is stationary), wireless signals transmitted by mobile beacon 311 and such reference beacon 313, as measured by active tracker 303, may vary in a similar manner over time (e.g., respective curves associated with mobile beacon 311 and reference beacon 313 may exhibit a relatively high measure of similarity).

While the above examples are presented in the context of a single mobile beacon 311, similar concepts may apply to multiple mobile beacons 311. For example, one or more active trackers 303 may receive wireless signals from multiple mobile beacons 311, in addition to receiving wireless signals from one or more reference beacons 313. Thus, measures of similarity may be determined for each mobile beacon 311-reference beacon 313 pair.

Process 200 may further include generating (at 206) per-reference beacon weights for one or more mobile beacons based on the measures of similarity between the wireless metrics associated with the one or more mobile beacons and one or more reference beacons. For example, the measures of similarity discussed above may be expressed in terms of scores or other values, and may be on varying scales or ranges. MBLS 103 may normalize such scores or values, such as by generating weights for each mobile beacon 311-reference beacon 313 pair.

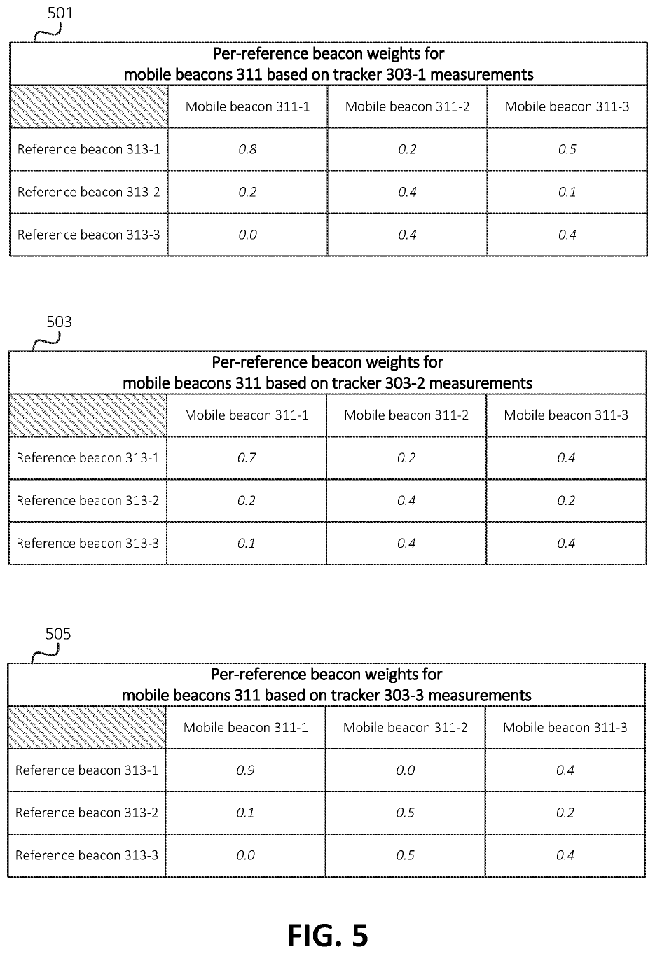

Data structures 501, 503, and 505 of FIG. 5 illustrate examples of such weights. Data structure 501 represents per-reference beacon weights for a set of mobile beacons 311 (e.g., mobile beacons 311-1, 311-2, and 311-3) based on wireless metrics as measured or reported by active tracker 303-1, data structure 503 represents per-reference beacon weights for mobile beacons 311 based on wireless metrics as measured or reported by active tracker 303-2, and data structure 505 represents per-reference beacon weights for mobile beacons 311 based on wireless metrics as measured or reported by active tracker 303-3. In accordance with some embodiments, generating the weights for a given mobile beacon 311 may include generating values that aggregate to a particular predetermined value, such as 1.0. Data structure 501 may be based on the information depicted in graph 301 (e.g., inasmuch as graph 301 depicts some of the information included in data structure 501, such as information relating to mobile beacon 311-1, reference beacon 313-1, and reference beacon 313-2), data structure 503 may be based on the information depicted in graph 401, and data structure 505 may be based on information depicted in graph 405.

In this example, data structure 501 indicates that mobile beacon 311-1 is associated with a weight of 0.8 with respect to reference beacon 313-1, a weight of 0.2 with respect to reference beacon 313-2, and 0.0 with respect to reference beacon 313-3. Generally, these weights may indicate that the wireless metrics measured or reported by active tracker 303-1 were relatively highly similar (e.g., 0.8 out of 1.0) between mobile beacon 311-1 and reference beacon 313-1. These weights may further indicate that the wireless metrics measured or reported by active tracker 303-1 were relatively less similar (e.g., 0.2 out of 1.0) between mobile beacon 311-1 and reference beacon 313-2, and were even less similar (e.g., 0.0 out of 1.0) between mobile beacon 311-1 and reference beacon 313-3. Thus, the per-reference beacon weights for mobile beacon 311-1, based on measurements from active tracker 303-1, are 0.8 for reference beacon 313-1, 0.2 for reference beacon 313-2, and 0.0 for reference beacon 313-3.

Similarly, data structure 501 further indicates that wireless metrics measured or reported by active tracker 303-1 were relatively moderately similar (e.g., 0.4 out of 1.0) between mobile beacon 311-2 and each of reference beacons 313-2 and 313-3, and were relatively dissimilar (e.g., 0.0 out of 1.0) between mobile beacon 311-2 and reference beacon 313-1. Thus, the per-reference beacon weights for mobile beacon 311-2, based on measurements from active tracker 303-1, are 0.2 for reference beacon 313-1, 0.4 for reference beacon 313-2, and 0.4 for reference beacon 313-3. In this manner, data structures 501, 503, and 505 may include respective per-reference beacon weights for various mobile beacons 311 based on measurements from various active trackers 303.

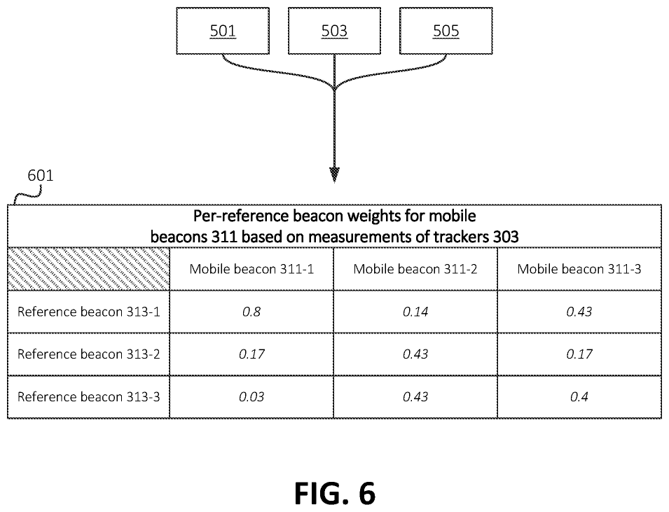

In accordance with some embodiments, MBLS 103 may generate an overall or aggregate per-reference beacon weight for each mobile beacon 311, where the overall per-reference beacon weight for a given mobile beacon 311 is based on measurements from multiple active trackers 303. For example, as shown in data structure 601 of FIG. 6, the per-reference beacon weights for mobile beacon 311-1, based on measurements from active trackers 303-1 through 303-3, are 0.8 for reference beacon 313-1, 0.17 for reference beacon 313-2, and 0.03 for reference beacon 313-3. In this example, these values are an average of the per-fixed weight beacons for mobile beacon 311-1, based on measurements from active trackers 303-1 through 303-3. For example, the weight of 0.8 for mobile beacon 311-1 and reference beacon 313-1 may be an average of: (a) the per-reference beacon weight of 0.8 for mobile beacon 311-1 and reference beacon 313-1, as measured by active tracker 303-1 (e.g., as shown in data structure 501), (b) the per-reference beacon weight of 0.7 for mobile beacon 311-1 and reference beacon 313-1, as measured by active tracker 303-2 (e.g., as shown in data structure 503), and (c) the per-reference beacon weight of 0.9 for mobile beacon 311-1 and reference beacon 313-1, as measured by active tracker 303-3 (e.g., as shown in data structure 505). The per-reference beacon weights for mobile beacons 311-2 and 311-3 may be determined in a similar manner. In some embodiments, some other function, technique, methodology, etc. may be used to generate the overall per-reference beacon weights for mobile beacons 311 (e.g., in lieu of, or in addition to, computing such weights based on an average, as discussed above).

Returning to FIG. 2, process 200 may further include receiving (at 208) reference beacon location information (e.g., reference beacon location information 101) over the particular time window. For example, as discussed above, MBLS 103 may receive configuration or installation information, indicating static or stationary locations at which reference beacons 313 are installed, affixed, mounted, etc. Additionally, or alternatively, MBLS 103 may receive location monitoring information or other dynamic location information indicating variable positions of one or more reference beacons 313 during the particular time period. As discussed above, such information may be collected or determined using any suitable techniques. In general, while such techniques may be used to identify dynamic locations of reference beacons 313, such techniques may be unavailable to identify locations of mobile beacons 311 during the same time period (e.g., mobile beacons 311 may be associated with a different system, may have different hardware capabilities, etc. than reference beacons 313).

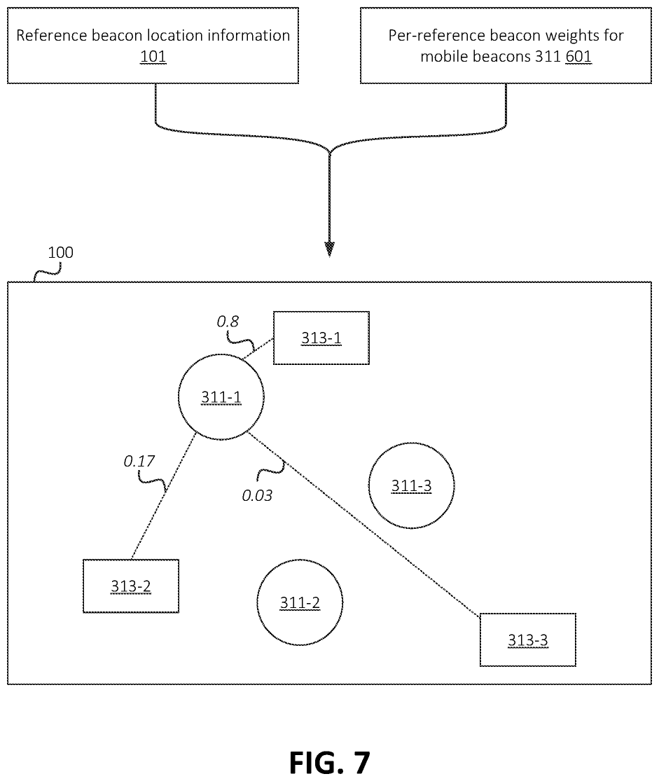

Process 200 may further include applying (at 210) the per-reference beacon weights (e.g., the overall per-reference beacon weights as represented in data structure 601) for each mobile beacon 311 to reference beacon location information 101, in order to localize mobile beacons 311 during the particular time window. FIG. 7 illustrates a representation of applying per-reference beacon weights for mobile beacons 311-1, 311-2, and 311-3 to reference beacon location information 101 for reference beacons 313-1, 313-2, and 313-3, in order to localize mobile beacons 311-1, 311-2, and 311-3 over the particular time period. As noted above, the overall per-reference beacon weight for mobile beacon 311-1 and reference beacon 313-1 is 0.8, in this example. Similarly, the overall per-reference beacon weight for mobile beacon 311-1 and reference beacon 313-2 is 0.17, and the overall per-reference beacon weight for mobile beacon 311-1 and reference beacon 313-3 is 0.03. These weights may be used to determine the distance between mobile beacon 311-1 and reference beacons 313-1, 313-2, and 313-3. For example, the weights may be inversely related to the distance of mobile beacon 311-1 to respective reference beacons 313. In other words, the weights may be proportional or indicative of the closeness or proximity of mobile beacon 311-1 to respective reference beacons 313. That is, as discussed above, since a higher weight indicates a higher measure of similarity of wireless metrics associated with mobile beacon 311-1 and a given reference beacon 313, the higher weight may indicate that mobile beacon 311-1 is located closer to such reference beacon 313. The location of mobile beacon 311-1, relative to reference beacons 313, such that the distances between mobile beacon 311-1 and each reference beacon 313 may be determined based on the respective per-reference beacon weight for mobile beacon 311-1 and each reference beacon 313.

For example, since mobile beacon 311-1 has a highest weight with respect to reference beacon 313-1 over the particular time window, it may be determined that mobile beacon 311-1 was closest to reference beacon 313-1 (e.g., out of the set of reference beacons 313) during the particular time window. Similarly, mobile beacon 311-1 may be determined to have been farther away from reference beacons 313-2 and 313-3 during the particular time period, as indicated by the lower weights for mobile beacon 311-1 with respect to reference beacons 313-2 and 313-3.

The techniques described herein may be used to determine the location of mobile beacons 311 relative to the locations of reference beacons 313. In situations where reference beacons 313 are stationary during the particular time period, a relatively high weight for mobile beacon 311-1 with respect to a given reference beacon 313 may indicate that mobile beacon 311-1 was also stationary during the particular time period and was located relatively close to such reference beacon 313. On the other hand, as noted above, in situations where a given reference beacon 313 is mobile during the particular time period, a relatively high weight for such mobile beacon 311 with respect to such reference beacon 313 may indicate that mobile beacon 311 was also mobile during the particular time period and was located relatively close to such reference beacon 313 while reference beacon 313 moved during the particular time period.

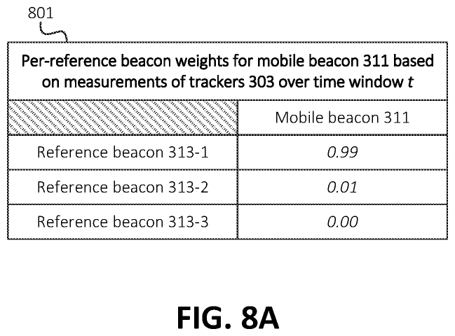

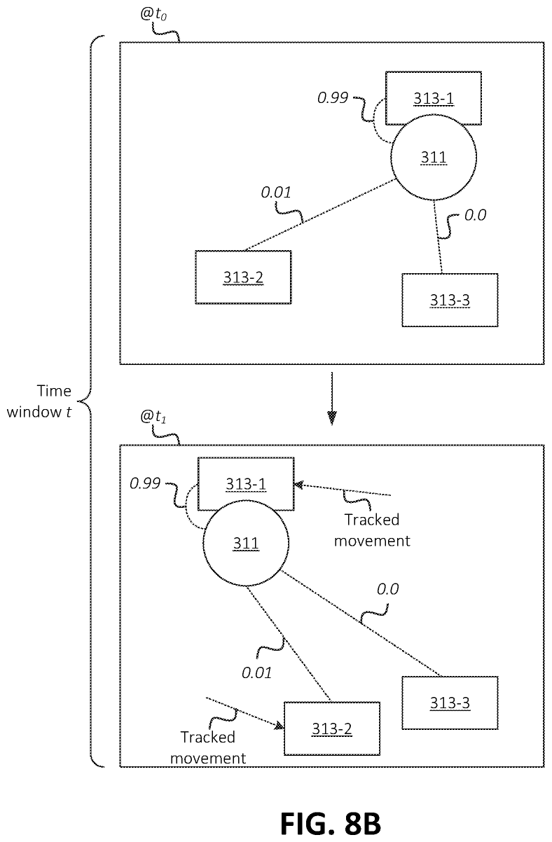

For example, as shown in FIG. 8, a particular mobile beacon 311 may be associated with per-reference beacon weights with respect to a set of reference beacons 313 (e.g., reference beacons 313-1, 313-2, and 313-3) based on measurements provided by one or more active trackers 303 over a particular time window t (e.g., over one second, over ten seconds, over two minutes, etc.). In this example, data structure 801 indicates that mobile beacon 311 is associated with a weight of 0.99 for reference beacon 313-1, a weight of 0.01 for reference beacon 313-2, and 0.0 for reference beacon 313-3. These values may generally indicate that wireless metrics associated with wireless signals transmitted by mobile beacon 311 were highly similar to wireless metrics associated with wireless signals transmitted by reference beacon 313-1 over time window t. This high measure of similarity may be due to, for example, a highly close proximity maintained between mobile beacon 311 and reference beacon 313-1 during the time window t (e.g., mobile beacon 311 and reference beacon 313-1 may have been co-located during some or all of the time window t). In situations where reference beacon 313-1 is moving during time window t, the location of mobile beacon 311 throughout the time window/may be determined based on (e.g., matching, in this example) the location of reference beacon 313-1 throughout time window t. As discussed above, since the location of reference beacon 313-1 is able to be monitored throughout time window t, the location of mobile beacon 311 may further be able to be monitored throughout time window t, even if mobile beacon 311 lacks functionality to determine or report its own location.

FIG. 8B illustrates an example scenario in which one or more reference beacons 313 may be moving throughout time window 1, and the location of mobile beacon 311 may be dynamically identified throughout time window t, in accordance with some embodiments. As shown, at a first time to, mobile beacon 311 and reference beacons 313-1, 313-2, 313-3 may be located at a first set of locations within a given space. While this figure is shown as a two-dimensional overhead view, similar concepts may apply for location determination in three dimensions. As further shown, at a second time t₁, which is within the same time window/as time to, reference beacons 313-1 and 313-2 may have moved within the space. For example, reference beacons 313-1 and 313-2 may be affixed to, integrated in, etc. one or more moving objects such as AGVs, forklifts, pallets, boxes, etc. As further shown, mobile beacon 311 may move in substantially the same manner as reference beacon 313-1. This movement over time, which is similar to or the same as the movement of reference beacon 313-1, may be a factor based on which the per-reference beacon weight of 0.99 was determined. As noted above, the movement of mobile beacon 311 may be due to, for example, being affixed to, carried on, stuck to, mounted on, etc. the same object as reference beacon 313-1.

In the manner described above, the location of one or more mobile beacons 311 may be determined relative to the locations of one or more reference beacons 313 (e.g., for which the location is known, monitored, or otherwise able to be determined), based on signal strength or other wireless metrics, as measured by one or more active trackers 303. As discussed above, such wireless signals may be transmitted (e.g., broadcasted) by mobile beacons 311 and reference beacons 313. Since the above-described techniques do not require mobile beacons 311 to have location determination capability or the ability to receive wireless communications, mobile beacons 311 may be relatively simple or inexpensive devices.

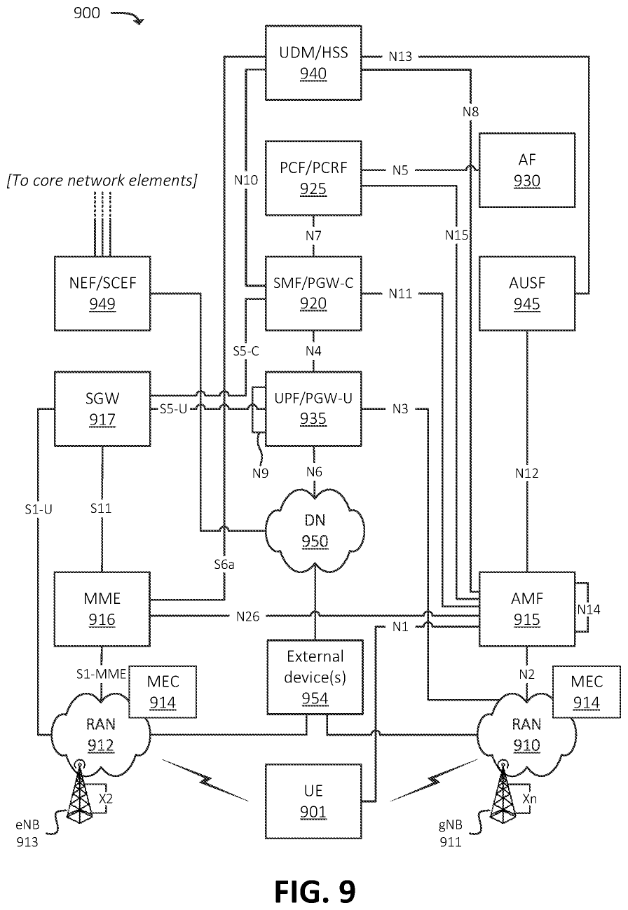

FIG. 9 illustrates an example environment 900, in which one or more embodiments may be implemented. In some embodiments, environment 900 may correspond to a 5G network, and/or may include elements of a 5G network. In some embodiments, environment 900 may correspond to a 5G Non-Standalone (“NSA”) architecture, in which a 5G radio access technology (“RAT”) may be used in conjunction with one or more other RATs (e.g., an LTE RAT), and/or in which elements of a 5G core network may be implemented by, may be communicatively coupled with, and/or may include elements of another type of core network (e.g., an evolved packet core (“EPC”)). In some embodiments, portions of environment 900 may represent or may include a 5G core (“5GC”). As shown, environment 900 may include UE 901, radio access network (“RAN”) 910 (which may include one or more Next Generation Node Bs (“gNBs”) 911), RAN 912 (which may include one or more evolved Node Bs (“eNBs”) 913), and various network functions such as Access and Mobility Management Function (“AMF”) 915, Mobility Management Entity (“MME”) 916, Serving Gateway (“SGW”) 917, Session Management Function (“SMF”)/Packet Data Network (“PDN”) Gateway (“PGW”)-Control plane function (“PGW-C”) 920, Policy Control Function (“PCF”)/Policy Charging and Rules Function (“PCRF”) 925, Application Function (“AF”) 930, User Plane Function (“UPF”)/PGW-User plane function (“PGW-U”) 935, Unified Data Management (“UDM”)/Home Subscriber Server (“HSS”) 940, Authentication Server Function (“AUSF”) 945, and Network Exposure Function (“NEF”)/Service Capability Exposure Function (“SCEF”) 949. Environment 900 may also include one or more networks, such as Data Network (“DN”) 950. Environment 900 may include one or more additional devices or systems communicatively coupled to one or more networks (e.g., DN 950), such as one or more external devices 954.

The example shown in FIG. 9 illustrates one instance of each network component or function (e.g., one instance of SMF/PGW-C 920, PCF/PCRF 925, UPF/PGW-U 935, UDM/HSS 940, and/or AUSF 945). In practice, environment 900 may include multiple instances of such components or functions. For example, in some embodiments, environment 900 may include multiple “slices” of a core network, where each slice includes a discrete and/or logical set of network functions (e.g., one slice may include a first instance of AMF 915, SMF/PGW-C 920, PCF/PCRF 925, and/or UPF/PGW-U 935, while another slice may include a second instance of AMF 915, SMF/PGW-C 920, PCF/PCRF 925, and/or UPF/PGW-U 935). The different slices may provide differentiated levels of service, such as service in accordance with different Quality of Service (“QoS”) parameters.

The quantity of devices and/or networks, illustrated in FIG. 9, is provided for explanatory purposes only. In practice, environment 900 may include additional devices and/or networks, fewer devices and/or networks, different devices and/or networks, or differently arranged devices and/or networks than illustrated in FIG. 9. For example, while not shown, environment 900 may include devices that facilitate or enable communication between various components shown in environment 900, such as routers, modems, gateways, switches, hubs, etc. In some implementations, one or more devices of environment 900 may be physically integrated in, and/or may be physically attached to, one or more other devices of environment 900. Alternatively, or additionally, one or more of the devices of environment 900 may perform one or more network functions described as being performed by another one or more of the devices of environment 900.

Additionally, one or more elements of environment 900 may be implemented in a virtualized and/or containerized manner. For example, one or more of the elements of environment 900 may be implemented by one or more Virtualized Network Functions (“VNFs”), Cloud-Native Network Functions (“CNFs”), etc. In such embodiments, environment 900 may include, may implement, and/or may be communicatively coupled to an orchestration platform that provisions hardware resources, installs containers or applications, performs load balancing, and/or otherwise manages the deployment of such elements of environment 900. In some embodiments, such orchestration and/or management of such elements of environment 900 may be performed by, or in conjunction with, the open-source Kubernetes” application programming interface (“API”) or some other suitable virtualization, containerization, and/or orchestration system.

Elements of environment 900 may interconnect with each other and/or other devices via wired connections, wireless connections, or a combination of wired and wireless connections. Examples of interfaces or communication pathways between the elements of environment 900, as shown in FIG. 9, may include an N1 interface, an N2 interface, an N3 interface, an N4 interface, an N5 interface, an N6 interface, an N7 interface, an N8 interface, an N9 interface, an N10 interface, an N11 interface, an N12 interface, an N9 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 9, such as Service-Based Interfaces (“SBIs”), including an Namf interface, an Nudm interface, an Npcf interface, an Nupf interface, an Nnef interface, an Nsmf interface, and/or one or more other SBIs.

UE 901 may include a computation and communication device, such as a wireless mobile communication device that is capable of communicating with RAN 910, RAN 912, and/or DN 950. UE 901 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 901 may send traffic to and/or receive traffic (e.g., user plane traffic) from DN 950 via RAN 910, RAN 912, and/or UPF/PGW-U 935. As discussed above, in some embodiments, UE 901 may include, may implement, may be implemented by, and/or may be communicatively coupled to one or more active trackers 303.

RAN 910 may be, or may include, a 5G RAN that implements a 5G RAT and that includes one or more base stations (e.g., one or more gNBs 911), via which UE 901 may communicate with one or more other elements of environment 900. UE 901 may communicate with RAN 910 via an air interface (e.g., as provided by gNB 911). For instance, RAN 910 may receive traffic (e.g., user plane traffic such as voice call traffic, data traffic, messaging traffic, etc.) from UE 901 via the air interface, and may communicate the traffic to UPF/PGW-U 935 and/or one or more other devices or networks.

Further, RAN 910 may receive signaling traffic, control plane traffic, etc. from UE 901 via the air interface, and may communicate such signaling traffic, control plane traffic, etc. to AMF 915 and/or one or more other devices or networks. Additionally, RAN 910 may receive traffic intended for UE 901 (e.g., from UPF/PGW-U 935, AMF 915, and/or one or more other devices or networks) and may communicate the traffic to UE 901 via the air interface.

RAN 912 may be, or may include, an LTE RAN that implements an LTE RAT and that includes one or more base stations (e.g., one or more eNBs 913), via which UE 901 may communicate with one or more other elements of environment 900. UE 901 may communicate with RAN 912 via an air interface (e.g., as provided by eNB 913). For instance, RAN 912 may receive traffic (e.g., user plane traffic such as voice call traffic, data traffic, messaging traffic, signaling traffic, etc.) from UE 901 via the air interface, and may communicate the traffic to UPF/PGW-U 935 (e.g., via SGW 917) and/or one or more other devices or networks. Further, RAN 912 may receive signaling traffic, control plane traffic, etc. from UE 901 via the air interface, and may communicate such signaling traffic, control plane traffic, etc. to MME 916 and/or one or more other devices or networks. Additionally, RAN 912 may receive traffic intended for UE 901 (e.g., from UPF/PGW-U 935, MME 916, SGW 917, and/or one or more other devices or networks) and may communicate the traffic to UE 901 via the air interface.

One or more RANs of environment 900 (e.g., RAN 910 and/or RAN 912) may include, may implement, and/or may otherwise be communicatively coupled to one or more edge computing devices, such as one or more Multi-Access/Mobile Edge Computing (“MEC”) devices (referred to sometimes herein simply as a “MECs”) 914. MECs 914 may be co-located with wireless network infrastructure equipment of RANs 910 and/or 912 (e.g., one or more gNBs 911 and/or one or more eNBs 913, respectively). Additionally, or alternatively, MECs 914 may otherwise be associated with geographical regions (e.g., coverage areas) of wireless network infrastructure equipment of RANs 910 and/or 912. In some embodiments, one or more MECs 914 may be implemented by the same set of hardware resources, the same set of devices, etc. that implement wireless network infrastructure equipment of RANs 910 and/or 912. In some embodiments, one or more MECs 914 may be implemented by different hardware resources, a different set of devices, etc. from hardware resources or devices that implement wireless network infrastructure equipment of RANs 910 and/or 912. In some embodiments, MECs 914 may be communicatively coupled to wireless network infrastructure equipment of RANs 910 and/or 912 (e.g., via a high-speed and/or low-latency link such as a physical wired interface, a high-speed and/or low-latency wireless interface, or some other suitable communication pathway).

MECs 914 may include hardware resources (e.g., configurable or provisionable hardware resources) that may be configured to provide services and/or otherwise process traffic to and/or from UE 901, via RAN 910 and/or 912. For example, RAN 910 and/or 912 may route some traffic from UE 901 (e.g., traffic associated with one or more particular services, applications, application types, etc.) to a respective MEC 914 instead of to core network elements of 900 (e.g., UPF/PGW-U 935). MEC 914 may accordingly provide services to UE 901 by processing such traffic, performing one or more computations based on the received traffic, and providing traffic to UE 901 via RAN 910 and/or 912. MEC 914 may include, and/or may implement, some or all of the functionality described above with respect to MBLS 103, UPF/PGW-U 935, AF 930, one or more application servers, and/or one or more other devices, systems, VNFs, CNFs, etc. In this manner, ultra-low latency services may be provided to UE 901, as traffic does not need to traverse links (e.g., backhaul links) between RAN 910 and/or 912 and the core network.

AMF 915 may include one or more devices, systems, VNFs, CNFs, etc., that perform operations to register UE 901 with the 5G network, to establish bearer channels associated with a session with UE 901, to hand off UE 901 from the 5G network to another network, to hand off UE 901 from the other network to the 5G network, manage mobility of UE 901 between RANs 910 and/or gNBs 911, and/or to perform other operations. In some embodiments, the 5G network may include multiple AMFs 915, which communicate with each other via the N14 interface (denoted in FIG. 9 by the line marked “N14” originating and terminating at AMF 915).

MME 916 may include one or more devices, systems, VNFs, CNFs, etc., that perform operations to register UE 901 with the EPC, to establish bearer channels associated with a session with UE 901, to hand off UE 901 from the EPC to another network, to hand off UE 901 from another network to the EPC, manage mobility of UE 901 between RANs 912 and/or eNBs 913, and/or to perform other operations.

SGW 917 may include one or more devices, systems, VNFs, CNFs, etc., that aggregate traffic received from one or more eNBs 913 and send the aggregated traffic to an external network or device via UPF/PGW-U 935. Additionally, SGW 917 may aggregate traffic received from one or more UPF/PGW-Us 935 and may send the aggregated traffic to one or more eNBs 913. SGW 917 may operate as an anchor for the user plane during inter-eNB handovers and as an anchor for mobility between different telecommunication networks or RANs (e.g., RANs 910 and 912).

SMF/PGW-C 920 may include one or more devices, systems, VNFs, CNFs, etc., that gather, process, store, and/or provide information in a manner described herein. SMF/PGW-C 920 may, for example, facilitate the establishment of communication sessions on behalf of UE 901. In some embodiments, the establishment of communications sessions may be performed in accordance with one or more policies provided by PCF/PCRF 925.

PCF/PCRF 925 may include one or more devices, systems, VNFs, CNFs, etc., that aggregate information to and from the 5G network and/or other sources. PCF/PCRF 925 may receive information regarding policies and/or subscriptions from one or more sources, such as subscriber databases and/or from one or more users (such as, for example, an administrator associated with PCF/PCRF 925).

AF 930 may include one or more devices, systems, VNFs, CNFs, etc., that receive, store, and/or provide information that may be used in determining parameters (e.g., quality of service parameters, charging parameters, or the like) for certain applications.

UPF/PGW-U 935 may include one or more devices, systems, VNFs, CNFs, etc., that receive, store, and/or provide data (e.g., user plane data). For example, UPF/PGW-U 935 may receive user plane data (e.g., voice call traffic, data traffic, etc.), destined for UE 901, from DN 950, and may forward the user plane data toward UE 901 (e.g., via RAN 910, SMF/PGW-C 920, and/or one or more other devices). In some embodiments, multiple instances of UPF/PGW-U 935 may be deployed (e.g., in different geographical locations), and the delivery of content to UE 901 may be coordinated via the N9 interface (e.g., as denoted in FIG. 9 by the line marked “N9” originating and terminating at UPF/PGW-U 935). Similarly, UPF/PGW-U 935 may receive traffic from UE 901 (e.g., via RAN 910, RAN 912, SMF/PGW-C 920, and/or one or more other devices), and may forward the traffic toward DN 950. In some embodiments, UPF/PGW-U 935 may communicate (e.g., via the N4 interface) with SMF/PGW-C 920, regarding user plane data processed by UPF/PGW-U 935.

UDM/HSS 940 and AUSF 945 may include one or more devices, systems, VNFs, CNFs, etc., that manage, update, and/or store, in one or more memory devices associated with AUSF 945 and/or UDM/HSS 940, profile information associated with a subscriber. In some embodiments, UDM/HSS 940 may include, may implement, may be communicatively coupled to, and/or may otherwise be associated with some other type of repository or database, such as a Unified Data Repository (“UDR”). AUSF 945 and/or UDM/HSS 940 may perform authentication, authorization, and/or accounting operations associated with one or more UEs 901 and/or one or more communication sessions associated with one or more UEs 901.

DN 950 may include one or more wired and/or wireless networks. For example, DN 950 may include an Internet Protocol (“IP”)-based PDN, a wide area network (“WAN”) such as the Internet, a private enterprise network, and/or one or more other networks. UE 901 may communicate, through DN 950, with data servers, other UEs 901, and/or to other servers or applications that are coupled to DN 950. DN 950 may be connected to one or more other networks, such as a public switched telephone network (“PSTN”), a public land mobile network (“PLMN”), and/or another network. DN 950 may be connected to one or more devices, such as content providers, applications, web servers, and/or other devices, with which UE 901 may communicate.

External devices 954 may include one or more devices or systems that communicate with UE 901 via DN 950 and one or more elements of 900 (e.g., via UPF/PGW-U 935). In some embodiments, external devices 954 may include, may implement, and/or may otherwise be associated with MBLS 103. External devices 954 may include, for example, one or more application servers, content provider systems, web servers, or the like. External devices 954 may, for example, implement “server-side” applications that communicate with “client-side” applications executed by UE 901. External devices 954 may provide services to UE 901 such as gaming services, videoconferencing services, messaging services, email services, web services, and/or other types of services.

In some embodiments, external devices 954 may communicate with one or more elements of environment 900 (e.g., core network elements) via NEF/SCEF 949. NEF/SCEF 949 include one or more devices, systems, VNFs, CNFs, etc. that provide access to information, APIs, and/or other operations or mechanisms of one or more core network elements to devices or systems that are external to the core network (e.g., to external device 954 via DN 950). NEF/SCEF 949 may maintain authorization and/or authentication information associated with such external devices or systems, such that NEF/SCEF 949 is able to provide information, that is authorized to be provided, to the external devices or systems. For example, a given external device 954 may request particular information associated with one or more core network elements. NEF/SCEF 949 may authenticate the request and/or otherwise verify that external device 954 is authorized to receive the information, and may request, obtain, or otherwise receive the information from the one or more core network elements. In some embodiments, NEF/SCEF 949 may include, may implement, may be implemented by, may be communicatively coupled to, and/or may otherwise be associated with a Security Edge Protection Proxy (“SEPP”), which may perform some or all of the functions discussed above. External device 954 may, in some situations, subscribe to particular types of requested information provided by the one or more core network elements, and the one or more core network elements may provide (e.g., “push”) the requested information to NEF/SCEF 949 (e.g., in a periodic or otherwise ongoing basis).

In some embodiments, external devices 954 may communicate with one or more elements of RAN 910 and/or 912 via an API or other suitable interface. For example, a given external device 954 may provide instructions, requests, etc. to RAN 910 and/or 912 to provide one or more services via one or more respective MECs 914. In some embodiments, such instructions, requests, etc. may include QoS parameters, Service Level Agreements (“SLAs”), etc. (e.g., maximum latency thresholds, minimum throughput thresholds, etc.) associated with the services.

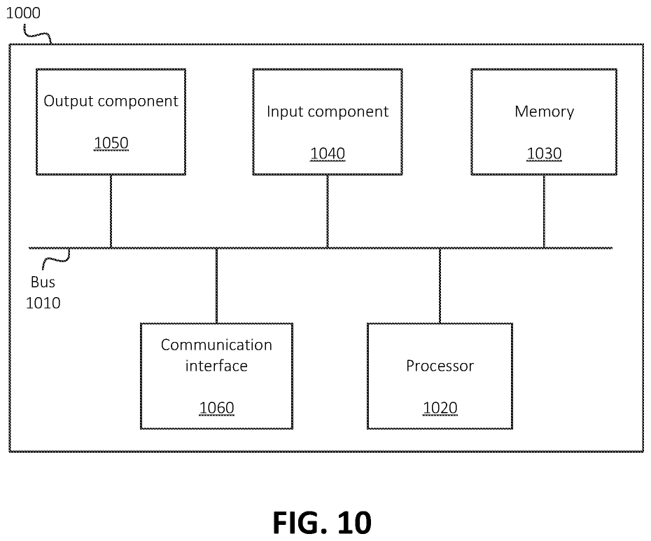

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a GPS-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems (e.g., via RAN 910, RAN 912, DN 950, etc.). For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-8B), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive a first plurality of sets of wireless metrics associated with wireless signals transmitted by a set of first devices, wherein the plurality of sets of wireless metrics are associated with a particular time window;
receive location information for each first device, of the set of first devices, over the particular time window;
receive a particular set of wireless metrics associated with wireless signals transmitted by a second device, wherein the particular set of wireless metrics associated with wireless signals transmitted by the second device are associated with the particular time window;
determine a respective measure of similarity between (a) the particular set of wireless metrics associated with wireless signals transmitted by a second device, and (b) each set of wireless metrics associated with wireless signals transmitted by the set of first devices;
determine a plurality of weights based on the determined measures of similarity, wherein each weight is associated with (a) the second device and (b) a respective first device of the set of first devices;
apply the weights, associated with the second device and each first device, to locations of corresponding first devices; and
determine a location of the second device, relative to one or more of the first devices, based on applying the weights.

2. The device of claim 1, wherein the wireless metrics associated with wireless signals transmitted by the set of first devices include a signal strength, as measured by one or more devices over the particular time window.

3. The device of claim 1, wherein the second device does not include a wireless receiver.

4. The device of claim 1, wherein the one or more processors are further configured to:
determine, based on the received location information for the set of first devices, that a particular first device, of the set of first devices, is moving during the time window,
wherein determining the location of the second device includes determining, based on the determination that the particular first device is moving, that the second device is moving during the time window.

5. The device of claim 4, wherein determining that the second device is moving is further based on a particular measure of similarity between (a) the particular set of wireless metrics associated with wireless signals transmitted by the second device, and (b) the set of wireless metrics associated with wireless signals transmitted by the particular first device.

6. The device of claim 1, wherein at least one or more first devices or the second device are stationary over the particular time window.

7. The device of claim 1, wherein receiving location information for each first device, of the set of first devices, over the particular time window includes receiving dynamically updated location information for the first devices over the particular time window.

8. A non-transitory computer-readable medium, storing a plurality of processor-executable instructions to:
receive a first plurality of sets of wireless metrics associated with wireless signals transmitted by a set of first devices, wherein the plurality of sets of wireless metrics are associated with a particular time window;
receive location information for each first device, of the set of first devices, over the particular time window;
receive a particular set of wireless metrics associated with wireless signals transmitted by a second device, wherein the particular set of wireless metrics associated with wireless signals transmitted by the second device are associated with the particular time window;
determine a respective measure of similarity between (a) the particular set of wireless metrics associated with wireless signals transmitted by a second device, and (b) each set of wireless metrics associated with wireless signals transmitted by the set of first devices;
determine a plurality of weights based on the determined measures of similarity, wherein each weight is associated with (a) the second device and (b) a respective first device of the set of first devices;
apply the weights, associated with the second device and each first device, to locations of corresponding first devices; and
determine a location of the second device, relative to one or more of the first devices, based on applying the weights.

9. The non-transitory computer-readable medium of claim 8, wherein the wireless metrics associated with wireless signals transmitted by the set of first devices include a signal strength, as measured by one or more devices over the particular time window.

10. The non-transitory computer-readable medium of claim 8, wherein the second device does not include a wireless receiver.

11. The non-transitory computer-readable medium of claim 8, wherein the plurality of processor-executable instructions further include processor-executable instructions to:
determine, based on the received location information for the set of first devices, that a particular first device, of the set of first devices, is moving during the time window,
wherein determining the location of the second device includes determining, based on the determination that the particular first device is moving, that the second device is moving during the time window.

12. The non-transitory computer-readable medium of claim 11, wherein determining that the second device is moving is further based on a particular measure of similarity between (a) the particular set of wireless metrics associated with wireless signals transmitted by the second device, and (b) the set of wireless metrics associated with wireless signals transmitted by the particular first device.

13. The non-transitory computer-readable medium of claim 8, wherein at least one or more first devices or the second device are stationary over the particular time window.

14. The non-transitory computer-readable medium of claim 8, wherein receiving location information for each first device, of the set of first devices, over the particular time window includes receiving dynamically updated location information for the first devices over the particular time window.

15. A method, comprising:
receiving a first plurality of sets of wireless metrics associated with wireless signals transmitted by a set of first devices, wherein the plurality of sets of wireless metrics are associated with a particular time window;
receiving location information for each first device, of the set of first devices, over the particular time window;
receiving a particular set of wireless metrics associated with wireless signals transmitted by a second device, wherein the particular set of wireless metrics associated with wireless signals transmitted by the second device are associated with the particular time window;
determining a respective measure of similarity between (a) the particular set of wireless metrics associated with wireless signals transmitted by a second device, and (b) each set of wireless metrics associated with wireless signals transmitted by the set of first devices;
determining a plurality of weights based on the determined measures of similarity, wherein each weight is associated with (a) the second device and (b) a respective first device of the set of first devices;
applying the weights, associated with the second device and each first device, to locations of corresponding first devices; and
determining a location of the second device, relative to one or more of the first devices, based on applying the weights.

16. The method of claim 15, wherein the wireless metrics associated with wireless signals transmitted by the set of first devices include a signal strength, as measured by one or more devices over the particular time window.

17. The method of claim 15, further comprising:
determining, based on the received location information for the set of first devices, that a particular first device, of the set of first devices, is moving during the time window,
wherein determining the location of the second device includes determining, based on the determination that the particular first device is moving, that the second device is moving during the time window.

18. The method of claim 17, wherein determining that the second device is moving is further based on a particular measure of similarity between (a) the particular set of wireless metrics associated with wireless signals transmitted by the second device, and (b) the set of wireless metrics associated with wireless signals transmitted by the particular first device.

19. The method of claim 15, wherein at least one or more first devices or the second device are stationary over the particular time window.

20. The method of claim 15, wherein receiving location information for each first device, of the set of first devices, over the particular time window includes receiving dynamically updated location information for the first devices over the particular time window.
